(19) United States
(12) Patent Application Publication
(10) Pub. No.: US 2025/0350828 A1
(43) Pub. Date: Nov. 13, 2025

(54) PARALLEL GRAPH RECONFIGURATION WITH INTERFACE SMOOTHING FOR CAMERA-TO-VIDEO TRANSITION

(71) Applicant: Apple Inc., Cupertino, CA (US)

(72) Inventors: Walker J Eagleston, San Francisco, CA (US); Neil G Crane, San Francisco, CA (US)

(21) Appl. No.: 18/949,264

(22) Filed: Nov. 15, 2024

Related U.S. Application Data
(60) Provisional application No. 63/646,047, filed on May 13, 2024.

(51) Int. Cl. H04N 23/667; H04N 23/63

(52) U.S. Cl. CPC H04N 23/667; H04N 23/632

(57) ABSTRACT

A device may cause activation of a camera application after detection of a first user interaction with a button of the user device. A device may while launching the camera application, initiating a photo capture mode causing one or more cameras on the user device to capture a scene of interest in a field of view of one or more cameras, wherein the initiating of the photo capture mode brings up a photo graph. A device may receive an indication of a second user interaction with the button to initiate a switch from the photo capture mode to a video capture mode, concurrently bringing down the camera graph to discontinue the photo capture mode and bringing up a video graph to activate the video capture mode. A device may allow the user device to begin recording video based on the second user interaction with the button of the user device.

### CROSS-REFERENCE TO RELATED APPLICATIONS

This application claims the benefit of priority to U.S. provisional application No. 63/646,047, filed on May 13, 2024, which is expressly incorporated by reference herein in its entirety.

### FIELD OF TECHNOLOGY

The present technology relates to facilitating fluid switching between photo and video capture functionalities on a user device.

### BACKGROUND

User devices have become increasingly integrated into everyday life, serving as indispensable tools for communication, productivity, and entertainment. Cameras are commonly integrated into this user device, which means users often have a camera with them. These cameras and camera applications are convenient and easy to use, allowing users to capture objects, scenes, and moments whenever they occur.

### BRIEF DESCRIPTION OF THE SEVERAL VIEWS OF THE DRAWINGS

Details of one or more embodiments of the subject matter described in this disclosure are set forth in the accompanying drawings and the description below. However, the accompanying drawings illustrate some typical embodiments of this disclosure and are therefore not to be considered limiting of its scope. Other features, embodiments, and advantages will become apparent from the description, the drawings, and the claims.

FIG. 1 illustrates an example device configured to perform photo capture and video capture in accordance with some embodiments of the present technology.

FIG. 2 illustrates an example architecture for detecting whether a camera application should be launched and whether a user intends to switch between photo and video capture in accordance with some embodiments of the present technology.

FIG. 3 illustrates an example flowchart for performing a determination of whether a switch between photo and video capture is to be performed in accordance with some embodiments of the present technology.

FIG. 4 illustrates an example process for initiating a switch between video capture to photo capture on a user device after receiving additional user interactions in accordance with some embodiments of the present technology.

FIG. 5 illustrates an example process for adjusting overscan when initiating a switch between photo and video capture modes, in accordance with some embodiments of the present technology.

FIG. 6 is an example process chart illustrating the transition between a video graph and photo graph during the switch between photo and video capture in accordance with some embodiments of the present technology.

FIG. 7 illustrates an overscan occurring during the switch between photo and video capture in accordance with some embodiments of the present technology.

FIG. 8A illustrates a first iteration of an example transition when performing a switch between photo and video capture mode while capturing media content in accordance with some embodiments of the present technology.

FIG. 8B illustrates a second iteration of an example transition when performing a switch between photo and video capture mode while capturing media content in accordance with some embodiments of the present technology.

FIG. 8C illustrates a third iteration of an example transition when performing a switch between photo and video capture mode while capturing media content in accordance with some embodiments of the present technology.

FIG. 9 is a system diagram illustrating a device in accordance with some embodiments of the present technology.

### DETAILED DESCRIPTION

Various examples of the disclosure are discussed in detail below. While specific implementations are discussed, it should be understood that this is done for illustration purposes. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and such references mean at least one of the examples.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative and is not intended to further limit the scope and meaning of the disclosure or of any example term. Likewise, the disclosure is not limited to various embodiments given in this specification.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

User devices, including mobile devices, tablets, and similar gadgets, frequently incorporate cameras that can be easily activated via interactions with the user interface or the device itself, either through software buttons on the interface or physical buttons on the device. With the camera app, users can easily switch between photo and video modes to adjust to their content needs. This feature allows users to transition from capturing still images to recording dynamic video footage without the need for manual adjustments or interruptions.

However, the transition from photo capture to video capture modes can often be prolonged, causing frustrations in the user's experience when attempting to capture a scene of interest in a fleeting moment. Tricks to mitigate this delay can lead to distortions in the imagery and a degradation of the captured content's quality within the camera application. Such reduced image quality typically stem from attempting to use frames in the previous camera mode in the new camera mode, abrupt switches in capture modes, resulting in inconsistencies in settings like focus, exposure, and stabilization. Moreover, the sluggish response time during this transition process frequently results in delays in capturing desired content, potentially causing users to miss crucial moments.

The disclosed technology addresses the above challenges by providing solutions for facilitating fast switching between photo and video capture functionalities on a user device. For example, the disclosed technology can bring up a video graph concurrently with bringing down a photo graph, whereas these processes are generally sequential because running the camera graph and especially the video graph already consumes available system memory and significant battery. Thus, concurrently bring down a photo graph or video graph while bringing up the opposite graph is a challenging technical problem.

The disclosed technology addresses the above challenges by providing solutions for facilitating fast switching between photo and video capture functionalities on a user device. For example, the disclosed technology can bring up a video graph concurrently to bringing down a photo graph. Additionally, achieving the fast transition between photo and video creates some challenges addressed by the disclosed technology. For example, the field of view of a photo and video are not the same, and an abrupt and fast transition can provide an undesirable user experience. Accordingly. The disclosed technology addresses these problems through field-of-view adjustments to mitigate abrupt changes between still image preview and video recording modes. Despite these adjustments, the technology provides methods to maintain video mode settings and frame rates to those achieved through traditional video functionality.

Accordingly, the examples described herein allow for quick mode switching while maintaining a good user interface experience.

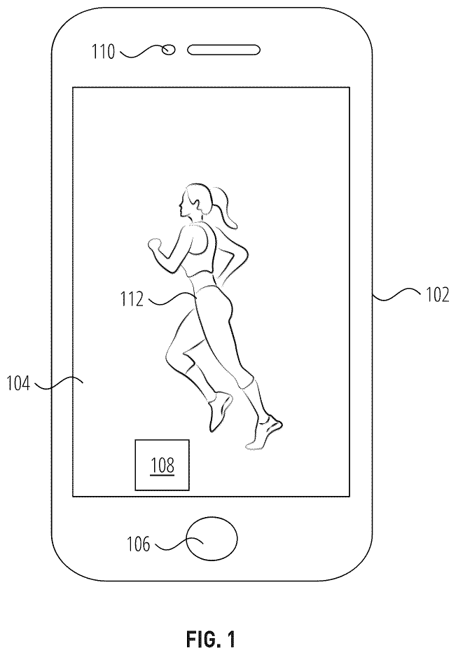

FIG. 1 illustrates an example device configured to perform photo capture and video capture in accordance with some embodiments of the present technology.

Users frequently encounter a scene of interest 112 that they wish to capture using their user device 102, whether it be a natural landscape, a candid moment, or a memorable event. To facilitate this, users can interact with either the physical button 106 or the software button 108 on the user device 102 to swiftly launch the camera application. Upon activation, the camera application engages the camera 110, whether it be the front or rear camera of the user device 102, enabling users to capture the scene of interest 112. The captured image or video is promptly displayed on the device's display 104, allowing users to review and assess the quality of the captured content.

As users engage with the captured content in a scene, the users may quickly switch between photo and video capture modes to capture the scene of interest 112. This can be achieved by interacting with either the software button 108 or the physical button 106, initiating a seamless transition between capture modes. Notably, this switching process allows for an efficient transition between photo and video capture, ensuring minimal disruption to the user experience while maintaining the direction of the one or more cameras to enable uninterrupted capture of the scene of interest.

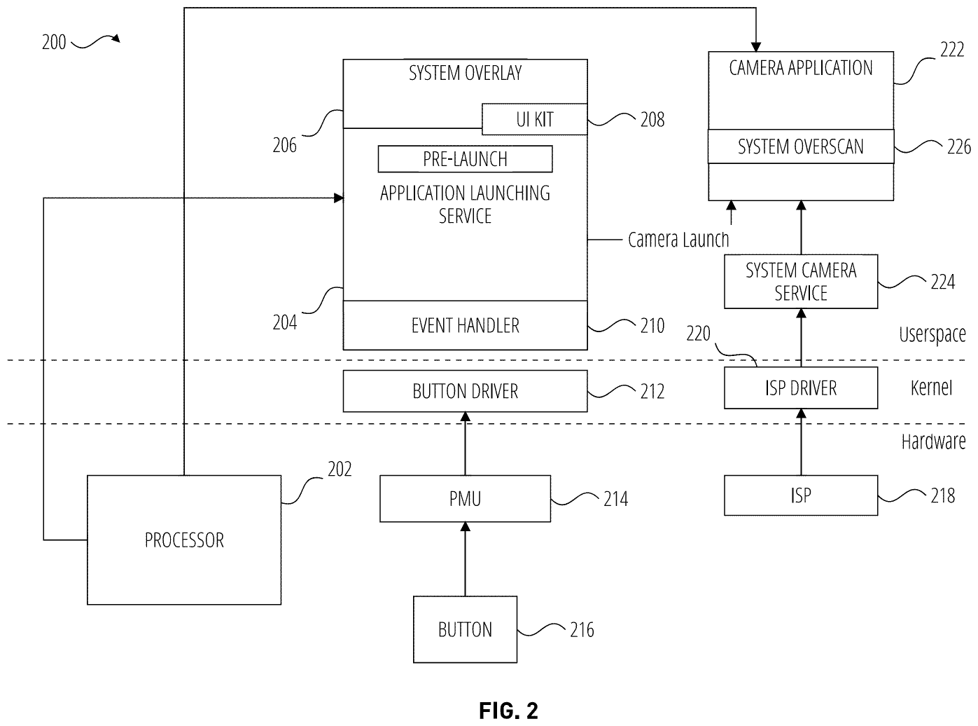

FIG. 2 illustrates an example architecture 200 for detecting whether a camera application should be launched and whether a user intends to switch between photo and video capture in accordance with some embodiments of the present technology.

A device application launching service 204 can be executed by a processor 202 to detect when a user interaction has initiated the launch of an application, such as the camera application. The processor 202 is responsible for handling user interactions, particularly when a button 216 is pressed on the user device. Processor 202 is responsible for detecting and interpreting these button 216 presses, and translating them into actionable signals for the user device operating system. Upon receiving an indication that button 216 has been pressed, processor 202 can communicate with the application launching service 204.

The application launching service 204 coordinates the launch of various applications, including essential functionalities like the camera application. Leveraging its processing capabilities, the processor 202 assists the application launching service 204 in initializing and executing procedures to launch the camera application seamlessly. This involves loading the camera application's code and resources into memory, initializing its components, and rendering a user interface associated with the camera application on a display of the user device.

Processor 202 also facilitates the launching of camera application 222 within the camera application. By interfacing with application launching service 204, processor 202 ensures that camera application 222 is activated and ready to interface with the device's camera hardware, including one or more cameras on the user device. This entails initializing the camera sensors, configuring camera settings, and managing the capture and processing of images or video frames.

In an example, upon determining that the application has been launched as a result of a user interaction with button 216, application launching service 204 can launch the camera application, and initiate camera application 222. Camera application 222 can be a part of camera application configured to activate one or more cameras on the user device to provide media streams to verify whether a scene of interest is present. In some examples, the system camera service 224 in userspace mediates access to the Image Signal Processor (ISP) 218. This service can receive signals from the ISP via an ISP driver 220, which processes image data captured by one or more cameras on the user device and delivers it to the system camera service 224. Camera application 222 can further include the ability to provide overscan 226, which extends the capture area beyond the visible boundaries of the display of the device. System overscan 226 is configured to affect the scene of interest as shown on the display of the device by ensuring that additional content, captured by the one or more cameras, outside the normal viewable frame of the display is captured.

In one example, the launching of the camera application can be initiated by an interaction detected with button 216. Button 216 can be a physical button. The power management unit (PMU) 214 can receive a signal from button 216. PMU 214 is responsible for managing the power consumption and distribution within the user device and regulating the voltage and current supplied to different device components. PMU 214 can send a signal to the button driver 212. An event created from the interaction with button 216 can be managed by event handler 210 in application launching service 204. Event handler 210 can also receive an interaction with a software button that can have some overlapping functionality with button 216. Event handler 210 is configured to provide the event handling and input management for user interactions with the user device user interface, such as touch events, gestures, and other inputs from the user, and relaying them to the appropriate applications or system components, such as application launching service 204, UI Kit 208, system overlay 206, or system overscan 226.

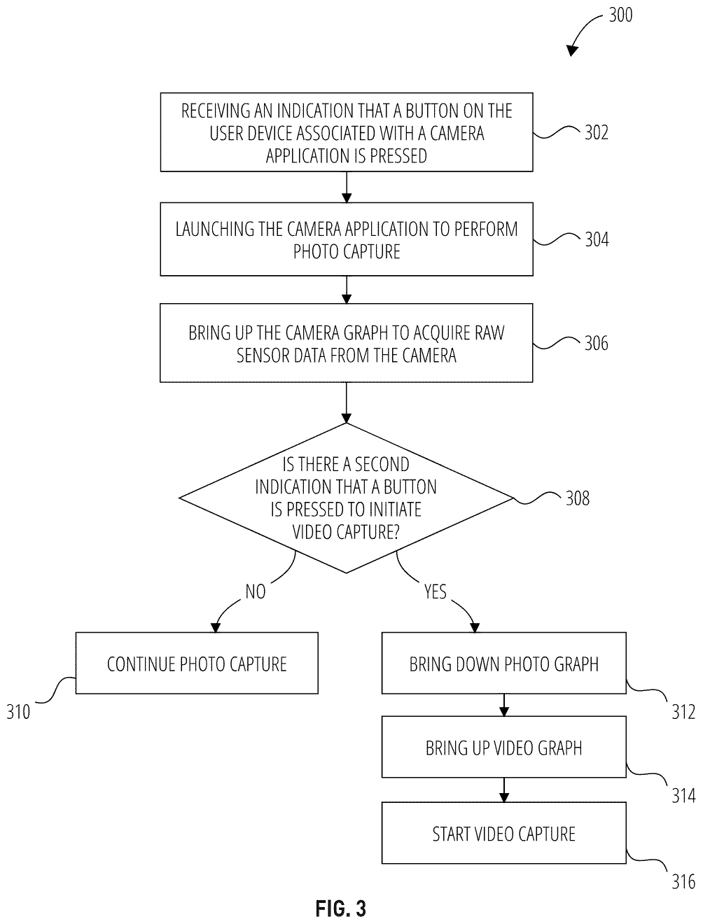

FIG. 3 illustrates an example flowchart for performing a determination of whether a switch between photo and video capture is to be performed in accordance with some embodiments of the present technology. Although the example process 300 depicts a particular sequence of operations, the sequence may be altered without departing from the scope of the present disclosure. For example, some of the operations depicted may be performed in parallel or in a different sequence that does not materially affect the function of the process 300. In other examples, different components of an example device or system that implements the process 300 may perform functions at substantially the same time or in a specific sequence.

According to some examples, the method includes receiving a signal indicating that a button linked to a camera application on the user device has been pressed, as depicted in block 302. For instance, processor 202, as shown in FIG. 2, may receive a signal indicating the activation of a button designated for launching the camera application 222. This button can take the form of either a physical button or a software button, both configured to trigger the initiation of the application.

In response to receiving the signal of user interaction with the button, the camera application can be launched to perform a photo capture, as depicted in block 304. The photo capture can be activated to cause the camera application to launch the photo capture mode based on a preset configuration or based on a particular interaction. The launch of the application subsequently activates one or more cameras on the user device, causing the cameras to begin to capture an object or scene of interest from the viewpoint of the cameras. For example, the camera application 222 depicted in FIG. 2 may activate a photo capture mode prompting one or more cameras on the user device to capture a scene of interest within their field of view.

This activation of the photo capture mode initiates the launching of the camera application, causing the “bring up” of a camera graph to acquire raw sensor data from one or more cameras at block 306. During this “bring up” process, the system is set to operate with zero shutter lag, allowing media capture to take place when the user perceives to have pressed the capture button, even though the final capture type—photo or video—is determined upon button de-activation or after a 416 ms threshold after the button was depressed. Consequently, an initial still photo capture is triggered at the time of button activation, regardless of whether the capture ultimately resolves as a photo or video. If the capture type resolves to a photo, the user perceives the capture moment as the button activation time, achieving a zero shutter lag experience. In certain scenarios, delays in media capture may occur due to factors like device shake from button activation, sensor readout delay, button event latency, and preview display latency, which can shift the ideal capture point to just before button activation. To address this, the camera application 222, shown in FIG. 2, uses a buffer to retain a continuous stream of recent sensor raw frames, allowing capture from frames recorded immediately prior to button activation.

To “bring up” a camera graph entails activating components in the photo processing pipeline and displaying a captured scene on the smartphone's screen. The “bring up” of a camera graph allows for the monitoring of various photographic signals relevant to the captured image, such as autofocus settings, exposure levels, and white balance adjustments. This functionality enables photographers to scrutinize the still image, facilitating adjustments for optimal image quality. Such adjustments may include fine-tuning exposure settings to ensure appropriate brightness levels across various frame areas, enhancing the overall quality of the media content.

The camera graph is a process that controls the capturing of an image through a camera application on a mobile device. It consists of several interconnected modules, each performing specific tasks in the image capture pipeline.

During photo capture mode, the camera graph obtains raw sensor data from the camera hardware. This data includes essential information about light intensity and color captured by the image sensor.

After acquiring the raw sensor data, the camera graph preprocesses it to correct distortions, reduce noise, and improve overall image quality. This preprocessing stage includes demosaicing, color correction, and noise reduction, which refine the raw data for further processing.

The preprocessed data is then fed into an image processing pipeline that performs tasks such as autofocus, exposure control, white balance adjustment, and tone mapping. These modules refine the image to ensure it meets desired quality standards for focus, brightness, color accuracy, and dynamic range.

Once the image processing pipeline is complete, the processed image undergoes additional post-processing steps. These steps involve further enhancements such as sharpening, contrast adjustment, and applying special effects, like filters or image stabilization, to improve its appearance.

Finally, the processed image is delivered to the user interface of the camera application as an output. Here, it is displayed for review and further action. Background photo processing is deferred until the ISP and camera have stopped running, at which point it utilizes a version of the camera graph that includes only the still image pipeline.

While capturing a photo, the user can switch to video capture mode by interacting with the button on the device. The indication for this transition occurs during the second interaction with either the software or physical button, where the camera application identifies the user's intention to switch between photo and video capture functionalities. Upon pressing the button for a designated period, the camera application can determine whether the second user interaction with the button is intended to initiate video capture mode, as shown in decision block 308. In some examples, the transition can include a user interface animation that appears unchanged from the photo capture mode to the video capture mode upon detection of the second user interaction.

Upon determining that the video capture mode is not activated, the camera application can continue operating in a photo capture mode, capturing still images of the scene of interest at block 310.

Upon determining that the video capture mode is to be activated, the camera application begins facilitating a transition to video capture mode by discontinuing photo capture mode. This involves concurrently bringing down a photo graph at block 312 and bringing up a video graph at block 314. Thus, the camera graph is deactivated by removing portions of the photo capture pipeline from device memory, while the camera application may still be displaying a frame captured using the photo graph.

A video graph includes aspects of a video processing pipeline that results in a visual representation of video content on a user device. It is similar to a camera graph used for still image capture and outlines the sequence of processing stages and modules involved in capturing, processing, and encoding video content.

The video graph includes components and functionalities dedicated to ensuring video footage's acquisition, stabilization, and refinement. These components include modules responsible for tasks such as frame acquisition, video stabilization to minimize shaky footage, exposure control for optimal lighting conditions, autofocus to maintain sharpness, white balance adjustment for accurate color representation, audio capture for synchronized sound recording, and video compression to encode the captured footage efficiently.

In order to transition from the photo graph to the video graph, a visual transition can occur that can include a crossfade animation from the last photo preview frame in SDR photo mode into streaming HDR video mode frames. During the visual transition a display tone mapping parameters are ramped in sync with the crossfade animation. In some examples, the animation can be independent from a rebuilding of video graph when transitioning from the photo capture mode and a bring down of the photo graph. In some examples, the display tone mapping parameters can appear as a brightness ramp to the user.

Upon bring up of a video graph the video graph, the user interface shows video frames captured by the device's cameras, extending them beyond the visible display area through the implementation of overscan. While the video frame is initially displayed in overscan to aid in the visual transition from photo capture mode to video capture mode, the user can interact with the user interface to return to a display without overscan.

After the completion of the bring-up of the video graph, the camera application has transitioned into video capture mode, enabling users to initiate a video capture 316 through user interactions with one or more buttons on the user device, such as tapping the record button or holding it down, depending on the specific interface design of the application. For example, the camera application 222 illustrated in FIG. 2 may perform a video capture allowing the user device to begin recording video after further interaction with the button of the user device.

In some instances, the camera application can be configured to automatically record upon entering the video capture mode upon discontinuation of the photo capture mode. To revert to photo capture mode, the user can initiate another interaction with the button linked to the camera application. This action triggers the transmission of a signal to the camera application 222, prompting it to execute a switch back to the photo capture mode.

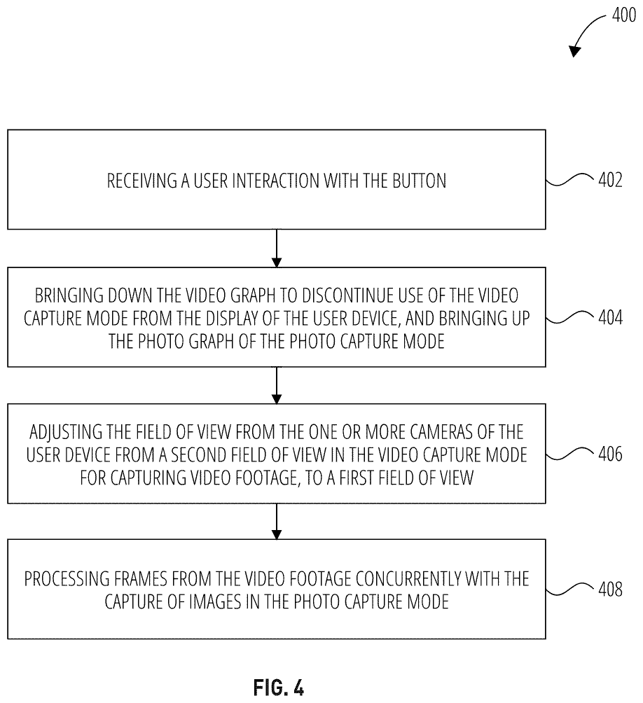

In some examples, a user device may receive supplementary signals denoting further user interactions with the button of the user device. Additional disclosure regarding switching between photo and video capture modes upon receiving additional user interactions to revert to a previous capture mode is elaborated in FIG. 4.

FIG. 4 illustrates an example process for initiating a switch between video capture to photo capture on a user device after receiving additional user interactions in accordance with some embodiments of the present technology. Although the example process 400 depicts a particular sequence of operations, the sequence may be altered without departing from the scope of the present disclosure. For example, some of the operations depicted may be performed in parallel or in a different sequence that does not materially affect the function of the process 400. In other examples, different components of an example device or system that implements the process 400 may perform functions at substantially the same time or in a specific sequence.

According to some examples, the method includes receiving a user interaction with the button at block 402. For example, the camera application 222 in FIG. 2 can receive a signal indicating a switch from video capture mode to photo capture mode upon the third user interaction with the button. Accordingly, upon receipt of the signal, a transition can be initiated from the photo capture mode to the video capture mode.

According to some examples, the method includes bringing down the video graph to discontinue use of the video capture mode, and concurrently bringing up the photo graph of the photo capture mode at block 404. For example, the camera application 222 illustrated in FIG. 2 may deactivate the video graph, thereby ceasing the utilization of the video capture mode on the user device's display, while concurrently activating the photo graph associated with the photo capture mode.

According to some examples, the activating of the photo capture via the user interface includes an exit transition that includes a cross fade between the running or last video frame into an SDR tone-mapped version of the same video frame is used to accomplish the inverse brightness ramp. Additionally, a display tone mapping parameter can be ramped down in sync with the cross fade. In some examples, the display tone mapping parameters can appear as a brightness ramp to the user. For example, the display tone mapping parameter can be an HDR brightness ramp that runs before a queue of the images are handed off to the photo graph for processing.

According to some examples, the method includes adjusting the field of view in accordance with the camera processing pipeline of the user device. The adjustment transitions the field of view from a second configuration optimized for capturing video footage to a first configuration tailored for capturing still images at block 406. For instance, the camera application 222 depicted in FIG. 2 may execute this adjustment within the camera processing pipeline. The first field of view is intended for capturing still images, while the second field of view is optimized for capturing video footage in the video capture mode.

In some examples, there may still be video frames residing in memory from the video graph that continue to be displayed until new frames from the photo graph are ready for display. Thus, the method includes processing frames from the video footage concurrently with capturing images in the photo capture mode at block 408. For example, the camera application may continue processing frames from the video footage even while capturing images in the photo capture mode. These frames, originating from the video capture mode, persist within the video buffer and require processing to be integrated into the recorded video footage. Following a switch to the photo capture mode from the video capture mode, this processing of video footage in the video buffer can persist in the background. The processing of the video footage in the background ensures that no delay is experienced within the camera application during active photo capturing, despite ongoing video footage processing. As video frames are processed, they are moved out of memory and into persistent storage freeing up memory to be dynamically reallocated from the video graph to the photo graph.

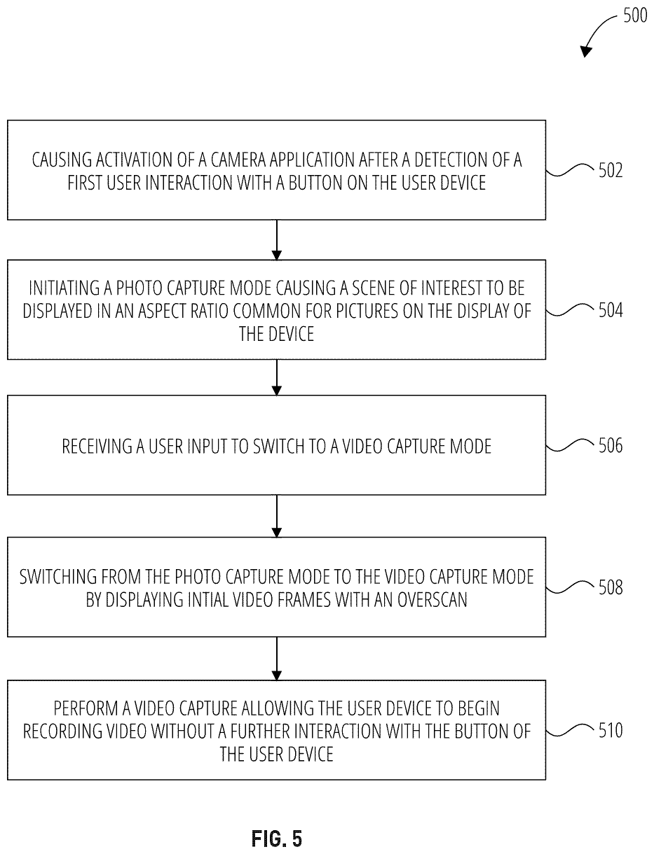

FIG. 5 illustrates an example process for adjusting overscan when initiating a switch between photo and video capture modes, in accordance with some embodiments of the present technology. Although the example routine 500 depicts a particular sequence of operations, the sequence may be altered without departing from the scope of the present disclosure. For example, some of the operations depicted may be performed in parallel or in a different sequence that does not materially affect the function of the routine 500. In other examples, different components of an example device or system that implements the routine 500 may perform functions at substantially the same time or in a specific sequence.

According to some examples, the method includes causing activation of a camera application after a detection of a first user interaction with a button on the user device at block 502. For example, the camera application 222 illustrated in FIG. 2 may be activated after the detection of a first user interaction with a button on the user device. The button can be one or more of a software button or physical button.

According to some examples, the method includes initiating a photo capture mode causing a scene of interest to be displayed in an aspect ratio common for pictures on the display of the device at block 504. For example, the camera application illustrated in FIG. 2 may display a scene of interest in an aspect ratio common for pictures on the display of the device.

According to some examples, the method includes receiving a user input to switch to a video capture mode at block 506. For example, the camera application 222 illustrated in FIG. 2 may receive a user input to switch to a video capture mode.

Since photos are displayed in a different aspect ratio than video frames, the speed at which the present technology switches modes from photo to video can result in an undesirable user experience whereby the aspect ratio of an image displayed by the camera application would abruptly switch, but for a compensation provided by the present technology at block 508, whereby this switch in aspect ratio transitions more naturally.

According to some examples, the method includes switching from the photo capture mode to the video capture mode by displaying initial video frames with an overscan while concurrently discontinuing the photo capture mode and activating the video capture mode at block 508. For example, the camera application 222 illustrated in FIG. 2 may switch from the photo capture mode to the video capture mode by displaying initial video frames with an overscan. By displaying the video frames in an overscan, portions of the video frames are off screen, but what is on screen is has an appearance closer to the photo frame displayed immediately before. This gives the appearance of a natural transition to capturing video frames, even though the aspect ratio has changed. In some examples, a user interface adjusts an overscan to match one or more attributes of a photo representation of the scene of interest and ensure continuity in image quality.

For the transition from photo capture to video capture there can be a cross-fade from the last SDR Photo mode frame into streaming HDR Video mode frames, and display tone mapping parameters are ramped in sync with the cross-fade animation. This appears mostly as a brightness ramp to the user.

In some embodiments, the switching from the photo capture mode to the video capture mode occurs through the concurrent bring down of the camera graph and the bring up of a video graph as described herein. In such embodiments, the last photo frames stored in the memory of the photograph are displayed on the screen until the video graph has sufficiently initialized to begin displaying video frames in overscan, as addressed above.

According to some examples, the method includes in response to the switch to the video capture mode, performing a video capture allowing the user device to begin recording video with in accordance with the second interaction with the button of the user device at block 510. For example, the camera application 222 illustrated in FIG. 2 may perform a video capture allowing the user device to begin recording video with a further interaction with the button of the user device.

After the video capture, it can be desired to switch back to the photo capture mode. On the exit transition from the video capture a cross-fade between the running or last HDR Video frame into an SDR tone-mapped version of the same Video frame is used to accomplish the inverse brightness ramp (with respect to the cross-fade from image capture to video capture, addressed above). Display tone mapping parameters are ramped down in sync with the cross-fade. The HDR brightness ramp runs before the image queue is handed off to the Photo graph (e.g., which can only render preview in SDR).

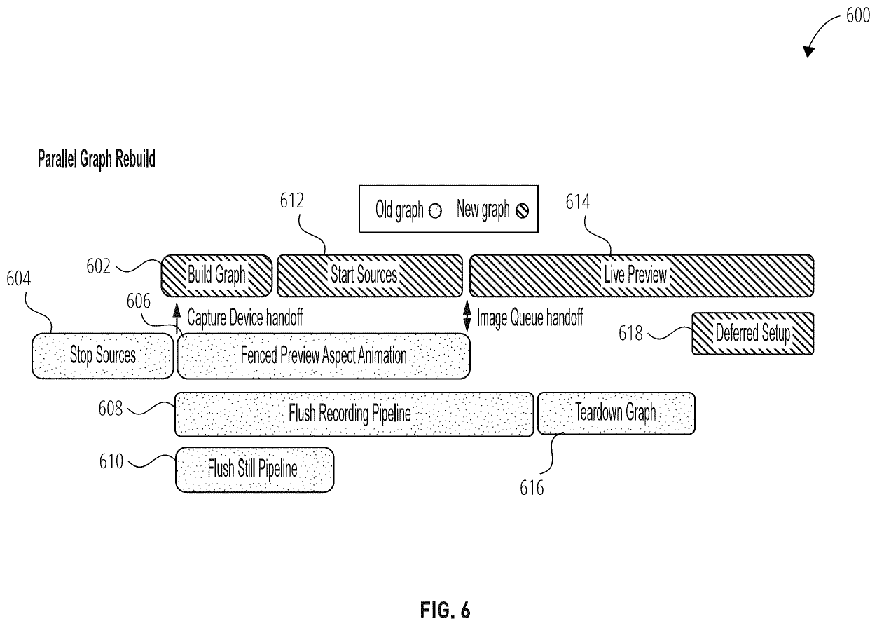

FIG. 6 is an example process chart 600 illustrating the transition between a video graph and photo graph during the switch between photo and video capture in accordance with some embodiments of the present technology. In particular, FIG. 6 generally outlines processes involved in bringing down a photo graph or video graph and bringing up a complementary graph during a capture mode switch.

The transition between photo capture mode and video capture mode, as depicted in FIG. 3, involves a plurality of actions. As discussed, the transition entails the “bring up” of the video graph and the “bring down” of the photo graph when transitioning to video capture mode, and conversely, FIG. 4 involves the “bring down” of the video graph and the bring up of the photo graph when transitioning to photo capture mode. Upon the initiation of a switch between photo capture mode and video capture mode, triggered by the pressing of a software or physical button on the user device, a concurrent bring down of one graph and a bring up of a complementary graph is set into motion, as illustrated in FIG. 6. This concurrent bring down of one graph and a bring up of the complementary graph facilitates the fast transition between the photo graph and the video graph.

Process chart 600 illustrates maintaining a resource flow between the video and photo modes during transition from video capture mode to photo capture mode or vice versa.

For example, upon receiving a signal indicating the user's interaction with the button, the camera application 222 causes a stop of sources 604 allocated for video capture mode, ceasing the ongoing recording process. Resources used by the video graph will be reallocated to photo capture mode as they become available. The reallocation of resources between the video graph and camera graph facilitates the handoff of memory resources. This process involves managing a memory pool wherein resources are dynamically allocated and deallocated based on the current operations being executed. The exact timing of these operations may vary with each execution. However, once the operations are completed, the resources, particularly memory, are released and made available for utilization by the “bring up” of the photo graph.

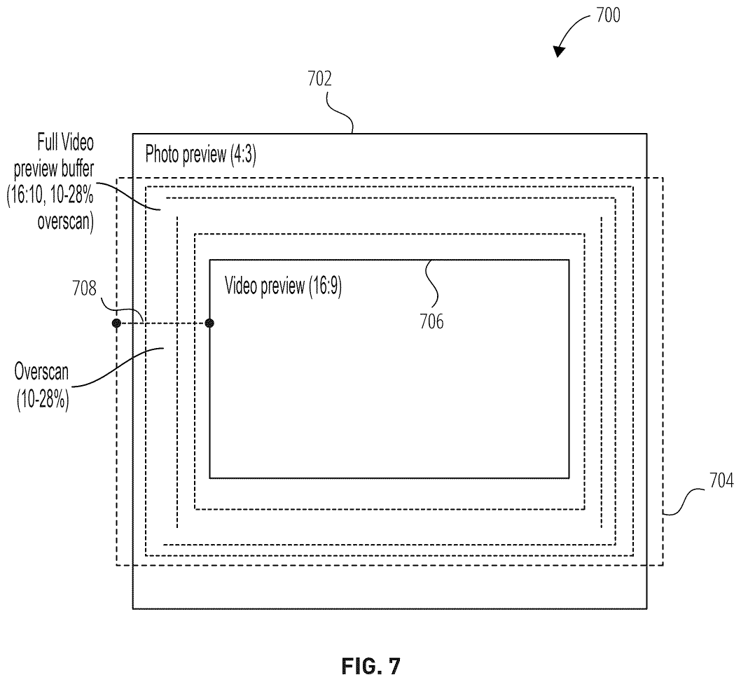

Following the stop of sources 604, the capture device handoff sequence commences. During this phase, the camera application initiates the build of the photo graph 602. Concurrently with the build of the photo graph 602, the fenced preview aspect animation 606 is initiated. The fenced preview aspect animation 606 facilitates a smooth adjustment of the preview window within the camera application's user interface, accommodating various display sizes and capture modes of the user device aspect ratio, as is addressed in more detail with respect to FIG. 7.

While the flushing of the video or photo pipeline could be handled by a dump of frames in the pipeline, the present technology allows these frames to continue to be processed until removed from memory. As memory is made available from processing the video frames or photo frames in the pipeline, memory can be allocated to capturing frames for the complementary mode to which the camera application is switching—in this example, memory can be allocated to capturing photo frames.

Once the capture device handoff concludes, an image queue handoff is initiated where sources are started 612. This process encompasses the transfer to an image live preview 614. In this example, video frames are no longer presented, and now photo frames are presented in the live preview, representing the image to be captured by the cameras in photo capture mode. Concurrently, a bring down of the video graph 616 is initiated along with a deferred setup 618 of the camera graph. This deferred setup 618 remains pending until the completion of the bring down of the video graph 616.

Alternatively, when in photo capture mode, and a switch to video capture mode is initiated, the camera application 222 causes a stop of sources 604 allocated for photo capture mode, ceasing additional image captures. Resources used by the photo graph will be reallocated to video capture mode as they become available. The reallocation of resources between the photo graph and video graph facilitates the handoff of memory resources. This process involves managing a memory pool wherein resources are dynamically allocated and deallocated based on the current operations being executed. The exact timing of these operations may vary with each execution. However, once the operations are completed, the resources, particularly memory, are released and made available for utilization by the “bring up” of the video graph.

Following the stop of sources 604, the capture device handoff sequence commences. During this phase, the camera application initiates the build of the video graph 602. Concurrently with the build of the video graph 602, the fenced preview aspect animation 606 is initiated. The fenced preview aspect animation 606 facilitates a smooth adjustment of the preview window within the camera application's user interface, accommodating various display sizes and capture modes of the user device aspect ratio, as is addressed in more detail with respect to FIG. 7.

Concurrently with the fenced preview aspect animation 606 and the bring up of the video graph, any ongoing still capture(s) in progress at the time of the signal indicating the initiation of video capture mode are flushed from the still pipeline 610.

Note that the flush of the still pipeline 610 is illustrated as taking less time than the flush recording pipeline 608. This is because the flush of the still pipeline 610 is generally a faster process by virtue of the fact that there are likely less still images in the pipeline. However, if there is a large buffer of still images to process, flush of the still pipeline 610 could take as long or longer than the flush of the recording pipeline 608.

Once the capture device handoff concludes, an image queue handoff is initiated. This process encompasses the transfer of an image live preview 614 from the video graph, representing the video frames to be captured by the cameras in video capture mode. Concurrently, a bring down of the photo graph 616 is initiated along with a deferred setup 618 of the video graph. This deferred setup 618 remains pending until the completion of the bring down of the photo graph 616.

FIG. 7 illustrates a photo/video overscan diagram 700 occurring during the switch between photo and video capture in accordance with some embodiments of the present technology.

Since photos are displayed in a different aspect ratio than video frames, the speed at which the present technology switches modes from photo to video can result in an undesirable user experience whereby the aspect ratio of an image displayed by the camera application would abruptly switch, but for compensation provided by the present technology and described with respect to FIG. 7, whereby this switch in aspect ratio transitions more naturally.

In the photo/video overscan diagram 700, it is shown that the video preview 706 has a 16:9 aspect ratio, while the photo preview 702 has a 4:3 aspect ratio. To make video frames appear more similar to photo frames, an overscan of displayed video frames can be applied during a transition between photo and video capture. For instance, when in video capture mode, the video preview buffer 704 includes frames with an aspect ratio of 16:10. When an overscan 708 of 10-28% is applied to the frames when they are displayed, the video frames appear more similar to frames displayed as part of the photo preview 702. Thus, by displaying video frames in overscan, the user experience is improved during a fast transition between video capture mode and photo capture mode.

This adjustment of video frames into an overscan can be accomplished through a user interface animation. An animation can cause video frames to animate from the typical video preview 706 into a full video preview buffer 704, which results from displaying the video preview with an overscan. Subsequently, when the camera application cuts over to a photo preview, the photo can be displayed in its normal photo preview 702. As illustrated in FIG. 7 full video preview buffer 704 is more similar in size and appearance to photo preview 702 than video preview 706. Thus, the animation from full video preview buffer 704 to video preview 706 provides a good user experience to transition the video preview into the overscan display so that the user does not experience a harsh transition from video capture mode to photo capture mode.

Note that the user interface transition addressed with respect to FIG. 7 does not require the concurrent bring down of one camera graph with the bring up of a complementary camera graph as described herein. However, the concurrent switching of the video graphs can result in a fast transition that benefits from the user interface animation and overscan addressed herein.

Switching in the opposite direction, to ensure a smooth transition and continuous presentation from photo capture mode to video capture mode, the user interface can first present a photo preview 702 before switching to video capture mode upon receiving a signal that a button has initiated the transition. Once the switch to video capture mode occurs, the user interface can present a full video preview buffer 704. In some embodiments, the present technology can then initiate an animation to transition from full video preview buffer 704 to the video preview 706, or a user can manipulate the user interface of the camera application 222 to move from the display in overscan full video preview buffer 704 to a normal video preview 706.

For example, in the camera application determining an overscan percentage for front-facing and rear-facing cameras of the user device, the focus is on minimizing the noticeable transition between different photo and video capture modes. For example, in video mode with enhanced stabilization enabled, the overscan for the rear-facing camera (RFC) is set at 28% for 1080p resolution and 23% for 4K resolution, while the front-facing camera (FFC) maintains a consistent 10% overscan for both 1080p and 4K. When enhanced stabilization is disabled, the overscan for the RFC is reduced to 20% for 1080p and 15% for 4K, with the FFC still at 10% for both resolutions. In QuickTake mode, the RFC applies an 18% overscan for both 1080p and 4K, while the FFC continues to use a 10% overscan.

In some embodiments, the present technology also enables a fast switch from a first mode to a second mode and then back to the first mode using the techniques addressed herein. In such embodiments, a user might desire to be in a photo capture mode but then want to quickly capture a short video before returning to photo capture mode. For example, the camera application 222 can be in photo capture mode while a user presses and holds a button (software button or hardware) to switch to video capture mode temporarily. This switch occurs as addressed in herein with the concurrent bring down of the camera graph and bring up of a video graph, and/or utilizing the user interface transitions. Then, once the user has discontinued holding the button, the inverse switch can occur with the concurrent bring down of the video graph and the concurrent bring up of the photo graph, and/or utilizing the user interface transitions.

For example, upon the camera application 222 receiving a signal for a subsequent user interaction where the button is held for a period of time, the video preview 706 transitions to the full video preview buffer 704, followed by a recording of media content in the viewpoint of one or more cameras. Once an indication is received that the button has been released for a second period of time, a transition is initiated from the video capture mode back to the photo capture mode. As shown in FIG. 4, a switch can be performed between video capture to photo capture on a user device after receiving additional user interactions. In accordance with the previously discussed examples in FIG. 4, in an example, a user currently in photo capture mode can initiate, via a single user interaction, a quick transition to capture a video followed by returning to photo capture mode. The camera application 222, illustrated in FIG. 2, can receive an indication of a user interaction where a user is holding a button for a period of time to cause a video capture to occur in video capture mode. This action prompts the camera application 222 to deactivate the photo graph, halting the photo capture display and simultaneously activating the video graph for video capture mode. Additionally, the field of view is swiftly adjusted from a configuration optimized for still image capture to one tailored for video capture.

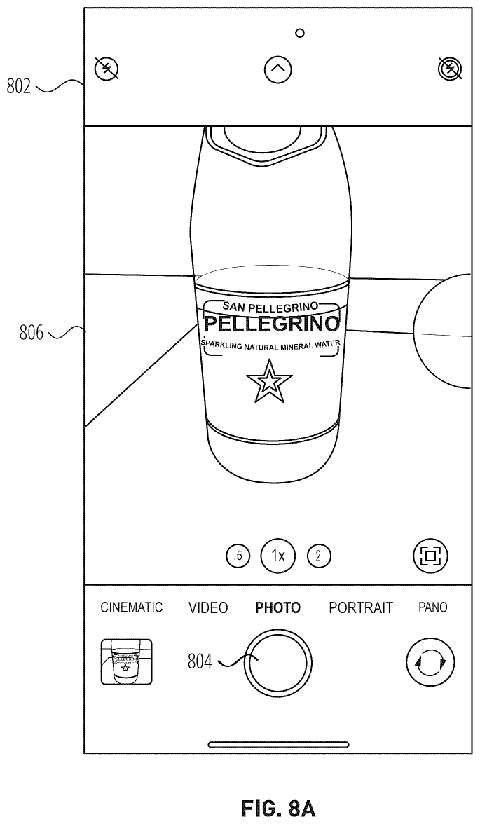

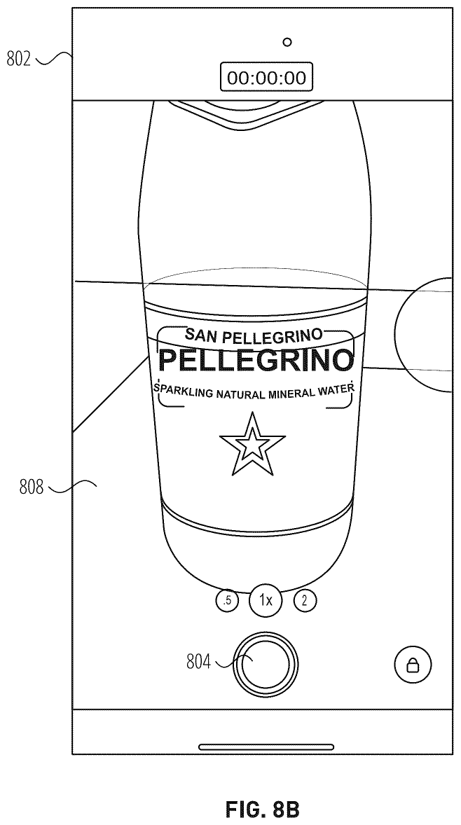

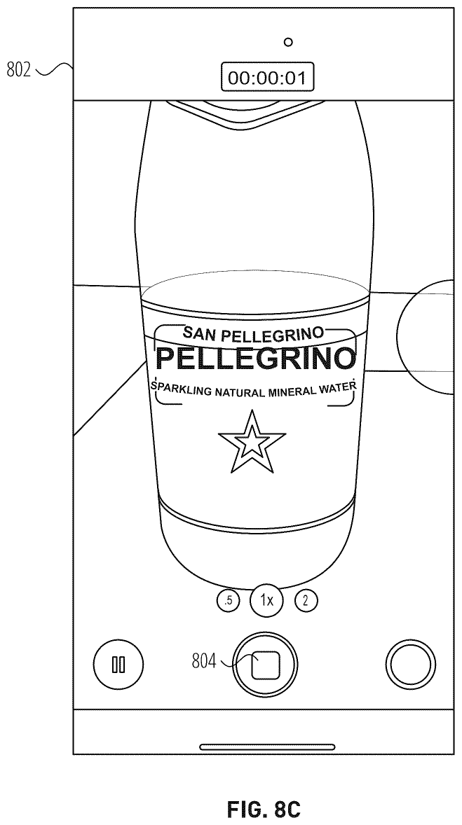

FIG. 8A-FIG. 8C depicts an example transition when performing a switch between photo and video capture mode while capturing media content in accordance with some embodiments of the present technology.

As shown in FIG. 8A, when the camera application is in photo capture mode, the photo preview 806 on the user device's display adopts an aspect ratio of 4:3. This aspect ratio is commonly associated with standard photo dimensions.

As shown in FIG. 8B, to initiate a switch from photo capture mode to video capture mode via the camera application of the user device, the user interacts with a designated button or interface element within the application. This interaction signals the application to transition from the current photo capture mode to the video capture mode. Upon receiving the signal, the camera application begins the process of discontinuing the photo capture mode and activating the video capture mode to video preview 808. Video preview 808 is displayed in an overscan as addressed herein.

During this transition process, various adjustments are made to the camera application 802 and underlying system to facilitate the smooth switch. This may include halting any ongoing photo capture processes, releasing resources allocated for photo capture mode, and reallocating them for video capture mode. Additionally, the user interface may undergo changes to accommodate the transition, such as adjusting the aspect ratio of the preview window to 16:9 display in an overscan while also activating overlays or controls specific to the video capture mode.

In some examples, an 18% overscan is employed when a rear-facing camera is present on the user device, particularly in 1080p resolution, to facilitate field of view adjustments from a video preview 706, as depicted in FIG. 7, to a photo preview 702. This overscan allows for smooth transitions between the video preview 706 and the photo preview 702, or vice versa, thereby reducing the need for user intervention to reframe or adjust the scene of interest within the field of view. Moreover, in scenarios where the resolution is 4K, an overscan range of 18-28% may be utilized for similar purposes.

Once the transition is complete, the camera application 802 is fully operational in video capture mode, allowing the user to begin recording by activating button 804 using one or more cameras, as shown in FIG. 8C. The video capture mode can be discontinued upon subsequent user interaction with the button 804, causing current video recordings to stop and activating the photo capture mode to capture still photos. The aspect ratio of the user interface subsequently reverts back to the 4:3 aspect ratio of FIG. 8A.

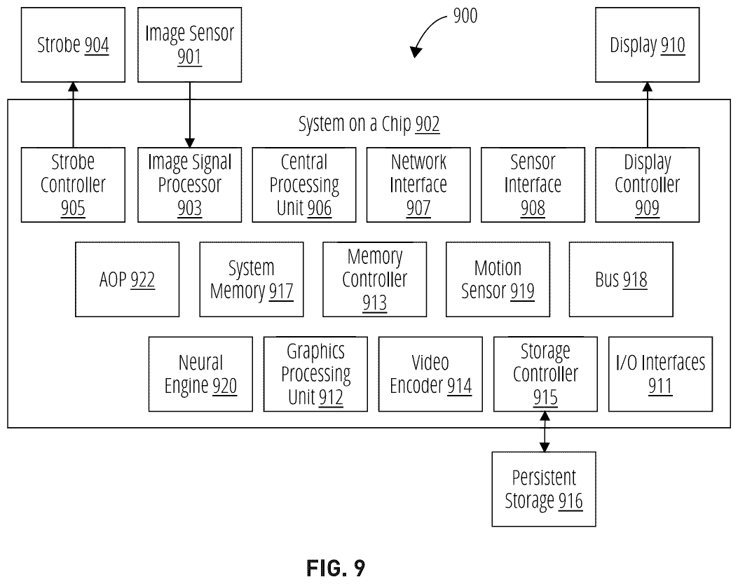

FIG. 9 is a system diagram illustrating device 900 in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

Device 900 may perform various operations including image processing. For this and other purposes, the device 900 may include, among other components, image sensor 901, system-on-a system on a chip 902, system memory 917, persistent storage 916, motion sensor 919, and display 910.

Image sensor 901 is a component for capturing image data and may be embodied, for example, as a complementary metal-oxide-semiconductor (CMOS) active-pixel sensor) a camera, video camera, or other devices. Image sensor 901 generates raw image data that is sent to system on a chip 902 for further processing. In some embodiments, the image data processed by system on a chip 902 is displayed on display 104, stored in system memory 917, persistent storage 916 or sent to a remote computing device via network connection. The raw image data generated by image sensor 901 may be in a Bayer color filter array (CFA) pattern (hereinafter also referred to as “Bayer pattern”).

Strobe controller 905 is a component for controlling variable features of strobe 904. Some attributes of the strobe 904 profile that can be adjusted include a strobe duration, a strobe strength, strobe spectrum, and an angular profile. For example, some strobe 904 devices can include strobes with adjustable intensities, and some strobe devices include multiple strobes, maybe with different emission spectra that can be activated independently to control an angular profile or spectrum of the light emitted from the strobe. An angular profile refers to the pattern and spread of light emitted from the strobe unit as it disperses over an area, as well as how this dispersion changes at different angles relative to the strobe. This can include how the intensity and distribution of light vary as one moves away from the central axis of the strobe, which is directly in front of it, towards the sides.

Motion sensor 919 is a component or a set of components for sensing motion of device 900. Motion sensor 919 may generate sensor signals indicative of orientation and/or acceleration of device 900. The sensor signals are sent to system on a chip 902 for various operations such rotating images displayed on display 910, and tracking motion of the image sensor 901 during image capture.

Display 910 is a component for displaying images as generated by system on a chip 902. Display 910 may include, for example, liquid crystal display (LCD) device or an organic light emitting diode (OLED) device. Based on data received from system on a chip 902, display 910 may display various images, such as menus, selected operating parameters, images captured by image sensor 901 and processed by system on a chip 902, and/or other information received from a user interface of device 900 (not shown).

System memory 917 is a component for storing instructions for execution by system on a chip 902 and for storing data processed by system on a chip 902. System memory 917 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof. In some embodiments, system memory 917 may store pixel data or other image data or statistics in various formats. System memory 917 can be accessible by many of the components of the system on a chip 902, including, but not limited to the central processing unit 906, graphics processing unit 912, and neural engine 920.

Persistent storage 916 is a component for storing data in a non-volatile manner. Persistent storage 916 retains data even when power is not available. Persistent storage 916 may be embodied as read-only memory (ROM), NAND or NOR strobe 904 memory or other non-volatile random access memory devices.

System on a chip 902 is embodied as one or more integrated circuit (IC) chips and performs various data processing processes. System on a chip 902 may include, among other components, Image Signal Processor 903, one or more central processing unit 906, always on processor (AOP) 922, network interface 907, sensor interface 908, display controller 909, one or more graphics processing unit 912, memory controller 913, video encoder 914, storage controller 915, one or more neural engine 920 and various other input/output (I/O) I/O interfaces 911, and bus 918. Some components of system on a chip 902 can be connected directly to system memory 917, while other components are connected to other components by bus 918. System on a chip 902 may include more or fewer components than those shown in FIG. 9.

Image Signal Processor 903 (ISP) is hardware that performs various stages of an image processing pipeline. In some embodiments, Image Signal Processor 903 may receive raw image data from image sensor 901, and process the raw image data into a form that is usable by other subcomponents of system on a chip 902 or components of device 900. Image Signal Processor 903 may perform various image-manipulation operations such as image translation operations, horizontal and vertical scaling, color space conversion and/or image stabilization transformations.

Central processing unit 906 (CPU) may be embodied using any suitable instruction set architecture, and may be configured to execute instructions defined in that instruction set architecture. Central processing unit 906 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 9, system on a chip 902 may include multiple CPUs. In multiprocessor systems, each of the CPUs may commonly, but not necessarily, implement the same ISA.

Graphics processing unit 912 (GPU) is graphics processing circuitry for performing graphical data. For example, GPU may render objects to be displayed into a frame buffer (e.g., one that includes pixel data for an entire frame). Graphics processing unit 912 may include one or more graphics processors that may execute graphics software to perform a part or all of the graphics operation, or hardware acceleration of certain graphics operations.

Neural engine 920 includes one or more processing cores optimized for machine learning tasks including training and inference tasks. Neural engine 920 enables rapid processing of artificial intelligence (AI) and machine learning (ML) operations. Neural engine 920 is optimized for tasks such as advanced image processing, natural language processing, and pattern recognition, significantly improving the efficiency and speed of AI-related processes. Its architecture is designed to support a wide range of machine learning models while being highly energy-efficient, thereby enhancing the user experience through faster, more responsive applications and functionalities that rely on AI and ML technologies.

I/O interfaces 911 are hardware, software, firmware or combinations thereof for interfacing with various input/output components in device 900. I/O components may include device such as keypads, buttons, audio devices, and sensors such as a global positioning system. I/O interfaces 911 process data for sending data to such I/O components or process data received from such I/O components.

Network interface 907 is enables data to be exchanged between device 900 and other devices via one or more networks (e.g., carrier or agent devices). For example, video or other image data may be received from other devices via network interface 907 and be stored in system memory 917 for subsequent processing (e.g., via a back-end interface to Image Signal Processor 903) and display 910. The networks may include, but are not limited to, Local Area Networks (LANs) (e.g., an Ethernet or corporate network) and Wide Area Networks (WANs). The image data received via network interface 907 may undergo image processing processes by Image Signal Processor 903.

Sensor interface 908 is circuitry for interfacing with motion sensor 919. Sensor interface 908 receives sensor information from motion sensor 919 and processes the sensor information to determine the orientation or movement of the device 900.

Display controller 909 is circuitry for sending image data to be displayed on display 104. Display controller 909 receives the image data from Image Signal Processor 903, central processing unit 906, graphics processing unit 912 or system memory 917 and processes the image data into a format suitable for display on display 910.

Memory controller 913 is circuitry for communicating with system memory 917. Memory controller 913 may read data from system memory 917 for processing by Image Signal Processor 903, central processing unit 906, graphics processing unit 912 or other subcomponents of system on a chip 902. Memory controller 913 may also write data to system memory 917 received from various subcomponents of system on a chip 902.

Video encoder 914 is hardware, software, firmware or a combination thereof for encoding video data into a format suitable for storing in persistent storage 916 or for passing the data to network interface 907 for transmission over a network to another device.

In some embodiments, one or more components of system on a chip 902 or some functionality of these components may be performed by software components executed on Image Signal Processor 903, central processing unit 906, graphics processing unit 912. Such software components may be stored in system memory 917, persistent storage 916 or another device communicating with device 900 via network interface 907.

Image data or video data may flow through various data paths within system on a chip 902. In one example, raw image data may be generated from the image sensor 901 and processed by Image Signal Processor 903, and then sent to system memory 917. After the image data is stored in system memory 917, it may be accessed by graphics processing unit 912, neural engine 920, and/or video encoder 914 for encoding or display 104.

In another example, image data is received from sources other than the image sensor 901. For example, video data may be streamed, downloaded, or otherwise communicated to the system on a chip 902 via wired or wireless network. The image data may be received via network interface 907 and written to system memory 917 via memory controller 913. The image data may then be obtained from system memory 917 and processed Image Signal Processor 903, graphics processing unit 912, or neural engine 920. The image data may then be returned to system memory 917.

For clarity of explanation, in some instances, the present technology may be presented as including individual functional blocks comprising devices, device components, steps, or routines in a method embodied in software or combinations of hardware and software.

Any of the steps, operations, functions, or processes described herein may be performed or implemented by a combination of hardware and software services or services, alone or in combination with other devices. In some embodiments, a service can be software that resides in the memory of a user device and/or one or more servers of a content management system and performs one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data that cause or otherwise configure a general-purpose computer, special-purpose computer, or special-purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Some aspects of the present technology include:

Clause 1. A method for initiating a switch between photo capture and video capture on a user device, the method comprising: causing activation of a camera application after a detection of a first user interaction with a button of the user device, wherein the button is a software button or physical button; while launching the camera application, initiating a photo capture mode causing one or more cameras on the user device to capture a scene of interest in a field of view of the one or more cameras, wherein the initiating of the photo capture mode brings up a photo graph configured to monitor for one or more photographic signals related to an image of a scene of interest in the field of view of the cameras captured on a display of the user device; receiving an indication of a second user interaction with the button, the second user interaction causing the camera application to initiate a switch from the photo capture mode to a video capture mode; switching from the photo capture mode to the video capture mode by concurrently bringing down the camera graph to discontinue the photo capture mode and bringing up a video graph to activate the video capture mode; and in response to the switch to the video capture mode, performing a video capture allowing the user device to begin recording video with in accordance with the second interaction with the button of the user device.

Clause 2. The method of clause 1, wherein bringing up the photo graph to perform the photo capture includes: acquiring raw sensor data from one or more sensors of the user device, wherein the raw sensor data includes the photographic signals including light intensity and color; performing one or more corrections to the raw sensor data to improve a quality of the image, the one or more corrections including correcting distortions, focus, color, an performing image stabilization and noise reduction in the image; and transmitting the image to a user interface of the camera application for display and further user interaction prior to saving of the image.

Clause 3. The method of clause 1, further comprising: after bringing up the video graph, displaying video frames captured by the one or more cameras of the user device displaying the video frames so that they are extended beyond a visible display area of the display to implement an overscan.

Clause 4. The method of clause 1, further comprising: receiving a third user interaction with the button, to initiate a switch from the video capture mode to photo capture mode; in response to receiving the third user interaction, concurrently bringing down the video graph to discontinue use of the video capture mode from the display of the user device, and bringing up the photo graph of the photo capture mode; adjusting the field of view from the one or more cameras of the user device from a second field of view in the video capture mode for capturing video footage, to a first field of view for capturing one or more images in the photo capture mode; and processing and recording frames from video footage concurrently with the capture of images in the photo capture mode, wherein the frames contribute to one or more still images in the activated photo capture mode.

Clause 5. The method of clause 1, wherein the switch to the video capture mode being activated after a period of time of pressing the button related to the second user interaction.

Clause 6. The method of clause 1, wherein the camera graph brought up in a user interface of the user device comprises graphical representations of autofocus settings, exposure levels, and white balance adjustments.

Clause 7. The method of clause 1, wherein the video graph brought up in a user interface of the user device comprises graphical representations of video resolution, frame rate, and audio recording settings.

1. A method for initiating a switch between photo capture and video capture on a user device, the method comprising:
causing activation of a camera application after a detection of a first user interaction with a button of the user device, wherein the button is a software button or physical button;
while launching the camera application, initiating a photo capture mode causing one or more cameras on the user device to capture a scene of interest in a field of view of the one or more cameras, wherein initiating of the photo capture mode brings up a photo graph configured to monitor for one or more photographic signals related to an image of the scene of interest in the field of view of the one or more cameras captured on a display of the user device;
receiving an indication of a second user interaction with the button, the second user interaction causing the camera application to initiate the switch from the photo capture mode to a video capture mode;
switching from the photo capture mode to the video capture mode by concurrently bringing down the photo graph to discontinue the photo capture mode and bringing up a video graph to activate the video capture mode; and
performing the video capture allowing the user device to begin recording video with in accordance with the second user interaction with the button of the user device.

2. The method of claim 1, wherein bringing up the photo graph to perform the photo capture includes:
acquiring raw sensor data from one or more sensors of the user device, wherein the raw sensor data includes the one or more photographic signals including light intensity and color;
performing one or more corrections to the raw sensor data to improve a quality of the image, the one or more corrections including correcting distortions, focus, color, performing image stabilization and noise reduction in the image; and
transmitting the image to a user interface of the camera application for display and further user interaction prior to saving of the image.

3. The method of claim 1, further comprising:
after bringing up the video graph, displaying video frames captured by the one or more cameras of the user device displaying the video frames so that they are extended beyond a visible display area of the display to implement an overscan.

4. The method of claim 1, further comprising:
receiving a third user interaction with the button, to initiate the switch from the video capture mode to the photo capture mode;
in response to receiving the third user interaction, concurrently bringing down the video graph to discontinue use of the video capture mode from the display of the user device, and bringing up the photo graph of the photo capture mode;
adjusting the field of view from the one or more cameras of the user device from a second field of view in the video capture mode for capturing video footage, to a first field of view for capturing one or more images in the photo capture mode; and
processing and recording frames from video footage concurrently with the photo capture of images in the photo capture mode, wherein the frames contribute to one or more still images in the photo capture mode that is activated.

5. The method of claim 1, wherein the switch to the video capture mode being activated after a period of time of pressing the button related to the second user interaction.

6. The method of claim 1, wherein the photo graph brought up in a user interface of the user device comprises graphical representations of autofocus settings, exposure levels, and white balance adjustments.

7. The method of claim 1, wherein the video graph brought up in a user interface of the user device comprises graphical representations of video resolution, frame rate, and audio recording settings.

8. A non-transitory computer-readable medium comprising instructions, the instructions, when executed by a computing system, cause the computing system to:
cause activation of a camera application after a detection of a first user interaction with a button of a user device, wherein the button is a software button or physical button;
while launching the camera application, initiate a photo capture mode causing one or more cameras on the user device to capture a scene of interest in a field of view of the one or more cameras, wherein initiating of the photo capture mode brings up a photo graph configured to monitor for one or more photographic signals related to an image of a scene of interest in the field of view of the one or more cameras captured on a display of the user device;
receive an indication of a second user interaction with the button, the second user interaction causing the camera application to initiate a switch from the photo capture mode to a video capture mode;
switch from the photo capture mode to the video capture mode by concurrently bringing down the photo graph to discontinue the photo capture mode and bringing up a video graph to activate the video capture mode; and
in response to the switch to the video capture mode, perform a video capture allowing the user device to begin recording video with in accordance with the second user interaction with the button of the user device.

9. The non-transitory computer-readable medium of claim 8, wherein the non-transitory computer-readable medium further comprises instructions that, when executed by the computing system, cause the computing system to:
acquire raw sensor data from one or more sensors of the user device, wherein the raw sensor data includes the one or more photographic signals including light intensity and color;
perform one or more corrections to the raw sensor data to improve a quality of the image, the one or more corrections including correcting distortions, focus, color, and performing image stabilization and noise reduction in the image; and
transmit the image to a user interface of the camera application for display and further user interaction prior to saving of the image.

10. The non-transitory computer-readable medium of claim 8, wherein the non-transitory computer-readable medium further comprises instructions that, when executed by the computing system, cause the computing system to:
after bringing up the video graph, display video frames captured by the one or more cameras displaying the video frames so that they are extended beyond a visible display area of a display to implement an overscan.

11. The non-transitory computer-readable medium of claim 8, wherein the non-transitory computer-readable medium further comprises instructions that, when executed by the computing system, cause the computing system to:
receive a third user interaction with the button, to initiate a switch from the video capture mode to the photo capture mode;
in response to receiving the third user interaction, concurrently bringing down the video graph to discontinue use of the video capture mode from the display of the user device, and bringing up the photo graph of the photo capture mode;
adjusting the field of view from the one or more cameras from a second field of view in the video capture mode for capturing video footage, to a first field of view for capturing one or more images in the photo capture mode; and
processing and recording frames from video footage concurrently with photo capture of images in the photo capture mode, wherein the frames contribute to one or more still images in the photo capture mode that is activated.

12. The non-transitory computer-readable medium of claim 8, wherein the switch to the video capture mode being activated after a period of time of pressing the button related to the second user interaction.

13. The non-transitory computer-readable medium of claim 8, wherein the photo graph brought up in a user interface of the user device comprises graphical representations of autofocus settings, exposure levels, and white balance adjustments.

14. The non-transitory computer-readable medium of claim 8, wherein the video graph brought up in a user interface of the user device comprises graphical representations of video resolution, frame rate, and audio recording settings.

15. A method for transitioning between photo capture and video capture modes on a user device, comprising:
causing activation of a camera application after a detection of a first user interaction with a button of the user device;
while launching the camera application, initiating a photo capture mode causing one or more cameras on the user device to capture a scene of interest in a field of view of the one or more cameras, while bringing up a photo graph configured to monitor photographic signals related to an image of a scene of interest in the field of view of the one or more cameras captured on a display of the user device;
receiving an indication of a second user interaction with the button, the second user interaction causing the camera application to initiate a switch from the photo capture mode to a video capture mode;
switching from the photo capture mode to the video capture mode by concurrently discontinuing the photo capture mode and activating of the video capture mode, wherein a user interface adjusts an overscan to match one or more attributes of a photo representation of the scene of interest and ensure continuity in image quality; and
in response to the switch to the video capture mode, performing a video capture allowing the user device to begin recording video with in accordance with the second user interaction with the button of the user device.

16. The method of claim 15, wherein bringing up the photo graph to perform the photo capture includes:
acquiring raw sensor data from one or more sensors of the user device, wherein the raw sensor data includes the photographic signals including light intensity and color;
performing one or more corrections to the raw sensor data to improve a quality of the image, the one or more corrections including correcting distortions, focus, color, performing image stabilization and noise reduction in the image; and
transmitting the image to the user interface of the camera application for display and further user interaction prior to saving of the image.

17. The method of claim 15, further comprising:
displaying video frames captured by the one or more cameras wherein the video frames are displayed so that they are extended beyond a visible display area of a display to implement an overscan.

18. The method of claim 15, further comprising:
receiving a third user interaction with the button, to initiate the switch from the video capture mode to the photo capture mode;
in response to receiving the third user interaction, adjusting the overscan by the user interface upon discontinuing use of the video capture mode from the display of the user device, and activating use of the photo capture mode;
adjusting the field of view from the one or more cameras of the user device from a second field of view in the video capture mode for capturing video footage, to a first field of view for capturing one or more images in the photo capture mode; and
processing and recording frames from the video concurrently with capture of images in the photo capture mode, wherein the frames contribute to the images in the photo capture mode that is activated.

19. The method of claim 15, wherein the switch to the video capture mode being activated after a period of time of pressing the button related to the second user interaction.

20. The method of claim 15, further comprising:
monitoring one or more adjustments to the overscan by the user interface during transition from photo capture mode to video capture mode;
assessing dimensions and resolution of the photo representation that is captured to verify that the one or more adjustments to the overscan for display of the image; and
dynamically scaling one or more user interface elements to match an aspect ratio and resolution of a representation of a captured image on the display, the one or more user interface elements including buttons, menus, and graphical overlays.

21. A method for initiating a switch between photo capture and video capture on a user device through a camera application, comprising:
activating the camera application upon detection of a first user interaction with a button of the user device, wherein the button is one or more of a software button or a physical button;
launching the camera application and initiating a photo capture mode, wherein the launching of the camera application causes the activation of one or more cameras on the user device to capture a scene of interest within a field of view of the one or more cameras;
receiving an indication of a second user interaction with the button, wherein the second user interaction causes the camera application to transition from the photo capture mode to a video capture mode, the transition including a user interface animation that appears unchanged from the photo capture mode to the video capture mode; and
executing the video capture mode, enabling the user device to commence recording video content upon further user interaction with the button of the user device.

22. The method of claim 21, wherein the transitioning from the photo capture mode to the video capture mode includes concurrently deactivating a photo graph to cease the photo capture mode, and activating a video graph to initiate the video capture mode.

23. The method of claim 21, wherein the animation is independent from a rebuilding of a video graph when transitioning from the photo capture mode and a bring down of the photo graph.

24. The method of claim 21, further comprising:
presenting via the camera application a photo preview before transitioning to video capture mode upon receipt of a signal indicating initiation of the transition from the photo capture mode; and
displaying a full video preview buffer followed by a video preview upon completion of the transition to video capture mode.

25. The method of claim 21, further comprising:
receiving an additional user interaction via the camera application to transition from the video capture mode to photo capture mode;
presenting via the camera application a video preview before switching to photo capture mode upon receiving a signal initiating the transition, the video preview configured to provide an uninterrupted presentation of a current video capture while activating the photo capture mode in a background of the camera application; and
displaying a photo preview upon completion of the transition to photo capture mode, wherein the photo preview comprises an overscan adjustment of the scene of interest in a photo capture.

26. The method of claim 21, wherein the camera application continues processing frames from still image capture in the photo capture mode within a photo buffer while capturing video footage in the video capture mode.

27. The method of claim 21, wherein following a transition back to the photo capture mode from the video capture mode, processing of video footage in a video buffer persists in a background of the camera application without interruption to still image capture in the photo capture mode.
